(19) United States
(12) Patent Application Publication
(10) Pub. No.: US 2002/0026346 A1
(43) Pub. Date: Feb. 28, 2002

(54) Method for internet survey using betting information

(76) Inventor: Bong-Ho Shin, Seoul (KR)

Correspondence Address: Kent E. Baldauf, 700 Koppers Building, 436 Seventh Avenue, Pittsburgh, PA, 15219-1818, US

(21) Appl. No.: 09/841,210

(22) Filed: Apr. 24, 2001

(30) Foreign Application Priority Data
Aug. 30, 2000 (KR) 2000-50910
Sep. 7, 2000 (KR) 2000-53060

(51) Int. Cl. G06F 17/60

(52) U.S. Cl. 705/10

(57) ABSTRACT

The present invention relates to a method for internet survey using betting information, and more particularly to a method for survey which analyzes selection click and betting amount of participant for plurality of subjects intending to survey during predetermined term through communicating network such as internet so as to analyze preference degree and preference strength for the surveying subject.

The method of the invention comprises steps: for selecting one subject among plural particular subjects desired to survey, deciding the betting amount desired to invest for selected subject, counting the selecting numbers to each of plural subjects desired to survey during particular term and betting amount whereby selecting a subject received most selecting number or betting, paying a dividend proportional to betting amount inputted to participant who selected a surveying subject received most selecting time number or betting amount, and analyzing a preference degree and preference strength on the basis of selecting number and betting amount for each of plural subjects desired to survey.

### BACKGROUND OF THE INVENTION

The present invention relates to a method for internet survey using betting information, and more particularly to a method for survey which analyze selection click and betting amount of participant for plurality of subjects intending to survey during predetermined term through communicating network such as internet so as to analyze preference degree and preference strength for a surveying subject.

Recently, various services are provided on internet together with tremendous increase of internet participants.

In the field of survey also, by emerging from that which has been executing a survey by using written letter, a survey is done for surveying preference degree to particular commodity, popularity degree to popular person, and response of people to affair having current eventuality, however participation to survey is avoided because there is none of substantial compensation returning to participant even participating to the survey, and there has been a problem that reliability of information sought by the survey is not so high because they do not faithfully answer in responding even participating to survey.

### OBJECT AND SUMMARY OF THE INVENTION

The present invention is invented in considering such points as above, and it is an object of the present invention to provide a method for survey in which in case of survey for surveying a preference degree to particular commodity, a popularity to popular person, a response of people to affair having current eventuality and so on, an economical interest of participant is made to be different according to choice of survey participant whereby the participant is induced to prudently act to the surveying subject so that reliability of surveying result can be increased.

And, another object of the present invention is to provide a method for survey capable of knowing not only to a preference degree or preference order to surveying subject but also to a preference strength for each surveying subject.

Further, still other object of the present invention to provide a method for survey in which unspecified participants participating to survey who is main body forming public opinion is made to register the subject of survey by themselves, and in case where the registered surveying subject is selected to a subject being highest in preference degree by a result of survey, a predetermined compensation would be paid to the participant registered to that subject, so that subject given by the main body forming public opinion can be effectively and easily found out.

A method of the present invention for attaining the object as above comprises: a step for connecting a computer of participant and a survey computer of web site executing the survey through internet whereby storing by inputting a plurality of subjects intending to survey and information related thereto; a step for indicating a plurality of said stored subjects and information related thereto to a participant's computer connected to said server computer so that a participant selects one subject among plurality of subjects ; a step for inputting a betting amount intending to invest to said selected one subject whereby transmitting to said server computer ; a step for collecting the selected numbers to each of plurality of subjects intending to survey during specific term whereby selecting one subject received most selected numbers; a step for paying a dividend proportional to inputted betting amount to a participant who selected a subject received most selecting numbers ; a step for analyzing a preference degree to each of plural subjects based on selected numbers to each of plural subjects intending to survey; and a step for analyzing a preference strength to each of plural subjects by sum of betting amount inputted to plural subjects intending to survey.

Moreover, a step is additionally comprised which makes to input a plurality of subjects intending to survey and information related thereto to any participant from said participant's computer whereby storing by transmitting to said server computer and thereby providing a particular compensation to a participant inputted with a subject received most selection clicks.

And, a method for survey using internet characterized to survey a preference degree and preference strength to surveying subject of the present invention further comprises: a step for storing by inputting a plurality of subjects intending to survey and information related thereto to said server computer; a step for indicating a plurality of said stored subjects and information related thereto to a participant's computer connected to said server computer so that the participant selects one subject among a plurality of subjects; a step for inputting a betting amount intending to invest to said selected one subject whereby transmitting to said server computer ; a step for collecting a betting amounts to each of plural subjects intending to survey during particular term whereby selecting one subject received most betting amount ; a step for paying a dividend proportional to inputted betting amount to a participant selected a subject received most betting amount; a step for analyzing a preference degree to each of plural subjects based on betting amounts sum to each of plural subjects intending to survey; and a step for analyzing a preference degree to each of plural subjects according to sum of betting amounts inputted to plural subjects intending to survey.

### BRIEF DESCRIPTION OF THE DRAWINGS

FIG. 1 is a schematic diagram of survey system for executing the present invention,

FIG. 2 is a flow chart of operation of an embodiment of surveying method in accordance with the present invention,

FIG. 3a an exemplary view of betting information by participant of one embodiment of the present invention,

FIG. 3b is a chart of selection click numbers collection by each surveying subject of the present invention,

FIG. 3c is a chart of betting amounts collection by each surveying subject of one embodiment of the present invention, and

FIG. 4 is a flow chart of operation of other embodiment of surveying method in accordance with the present invention.

### DETAILED DESCRIPTION OF THE INVENTION

Hereinafter, a method for survey for executing the present invention will be described more in detail with reference to the accompanying drawings.

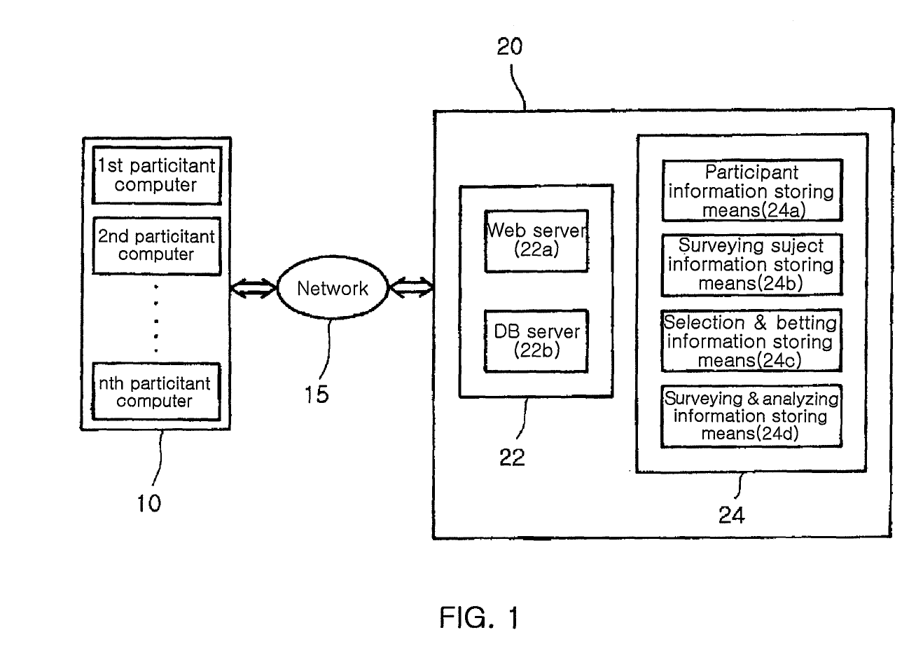

FIG. 1 is a schematic diagram of surveying system for executing the present invention, and which is constituted such that a surveying participant can connect to surveying system 20 through communication network 15 such as internet from participant computer 10, and the surveying system 20 includes a surveying server 22 and a data base 24.

The surveying server 22 includes a web server 22a which administrates an information of surveying participant connected to surveying system 20 through communication network 15 and selecting a surveying subject intending to execute by this invention whereby executing the survey and analyzing a result of survey by utilizing an information sought by surveying, and a DB server 22b which stores the information to data base 24 according to control of the web server 22a. and administrating it.

The data base 24 controlled by the DB server 22b includes a participant information storing means 24a for storing individual information of survey participant, a surveying subject information storing means 24b for storing a surveying subject and related information, a selection and betting information storing means 24c for storing a selection click information and betting information to each of surveying subjects by participant obtained in process executing the survey, and a surveying and analyzing information storing means 24d for analyzing a preference order information and preference strength information to each of surveying subjects by utilizing a selection click information and betting information whereby storing its result.

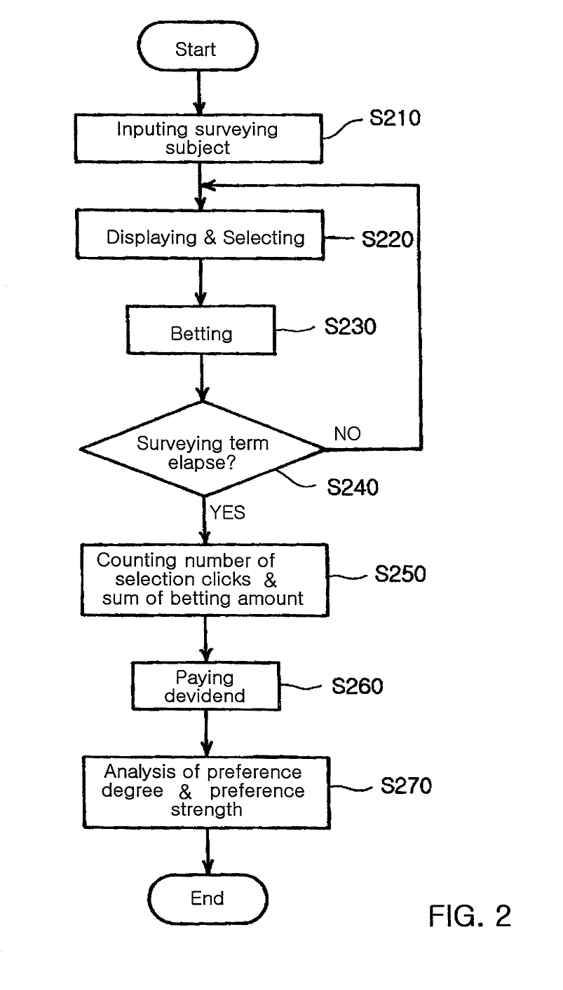

FIG. 2 is a flow chart of concrete progress of surveying method in accordance with the present invention.

At step S210, an operator of the surveying system 20 selects a subject intending to survey whereby stores a surveying subject and information related thereto to a surveying subject information storing means 24b. The surveying subject may be a plurality of same kind commodity having different brand in case of surveying a preference degree of consumer for particular commodity, and it may be a plurality of persons selected for the surveying subjects in case of surveying a popularity for particular persons.

At step S220, a surveying subject and information related to the surveying subject stored to the surveying subject information storing means 24b are provided to participant computer 10 connected to web server 22a of the surveying system, so that the participant selects one or plural subjects among plural surveying subjects.

Successively at step S230, a betting is executed for a subject selected by a participant.

At steps S220 and S230, the information related to the subject selected by a participant and betting amount are transmitted to the surveying system 20 through the communication network 15 such as internet whereby stored to the selection and betting information storing means 24c.

In this case, a betting can ever be done to only one subject among a plurality of surveying subjects, but the betting can also be executed to a plurality of surveying subjects.

In the present invention, what is said as a betting means an action investing a predetermined amount in which a survey participant has decided by oneself for a particular subject selected among plural subjects. In one embodiment of the present invention, the betting can be done by cyber money, and a predetermined amount of cyber money can be provided to a member at a step in which a survey participant firstly connects to a surveying system 20 and providing a personal information of own whereby joining for member, or the cyber money can be provided to a participant at a step in which a participant logs in to a surveying system whereby connecting thereto. And, the cyber money can be exchanged to a cash by a demand of participant when more than a predetermined amount is accumulated. A concrete technical matter required to provision and accumulation of such cyber money is already known, and concrete technique will be omitted because such technical matter is not a subject of protection of the present invention.

At step S240, a surveying term is previously established to the surveying subject, and the web server 22a judges whether or not the surveying time is elapsed and the steps S220 and S230 are made to be continuously executed in case when the surveying time is not terminated, and next step S250 is made to be executed in case when the surveying time is terminated.

At step S250, an information is utilized which related to the selection click and dividend amount done by participant which selected by the participant at participant computer and transmitted to web server whereby stored to the selection and betting information storing means 24C and thereby numbers of selection clicks and sum of betting amounts to each of surveying subject are collected at web server 22a.

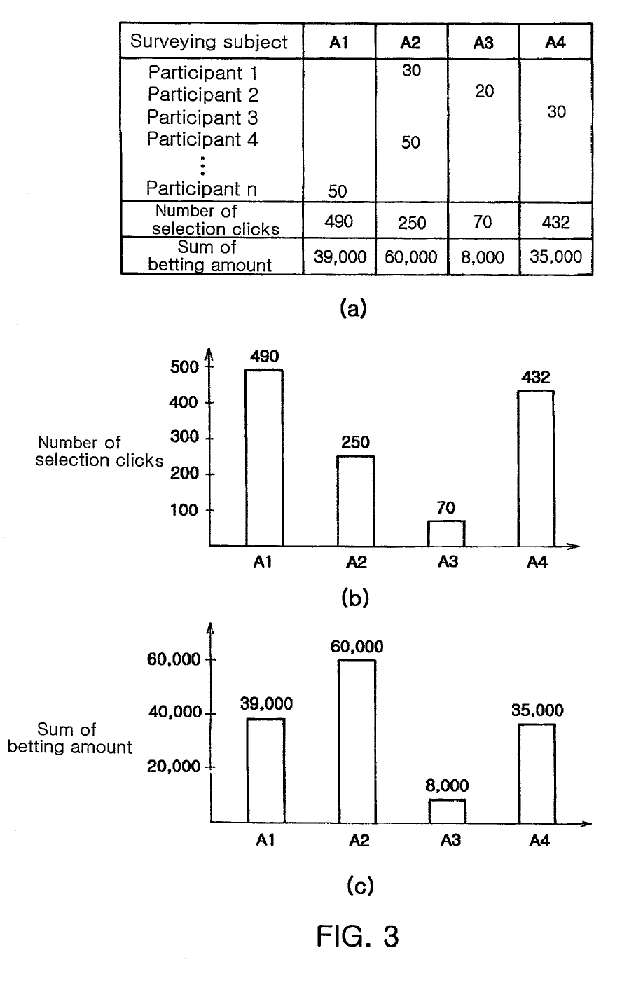

FIG. 3a exemplifies a content in which the surveying subjects are four of A1, A2, A3 and A4, and n persons of participants select the subject preferred by each person among surveying subjects to each of surveying subject, and amount decided by each person is betted for selected subject.

At step S260, a step is executed which pays dividend to participant at web server 22a based on numbers of time of calculated selection clicks and sum of betting amount.

The dividend is payed with total amount of betting amounts of whole participants participated to survey in accordance with the present invention or money amount excluding a part of amount among the betting total amount in proportion to amount betted to participant who selected the surveying subject received most selection clicks.

And, the dividend is not entirely payed to participant who could not select a surveying subject received most selection clicks. In one embodiment of the present invention, a dividend is payed which is proportional to amount betted to a participant who selected the survey subject received most selection clicks. This method can be applied in case when an influence ability of participant is same or similar to each of surveying subject.

For instance, in case of survey for surveying a supporting rate and winning probability for expected candidate in president election, a specific weight which influences to election result by selection of participant individual is respectively same and in case of survey of such form, it can be anticipated that a preference degree of participant for the surveying subject received most selection clicks is highest.

In other embodiment of the present invention, a dividend is payed which is proportional to an amount betted to participant who selected the surveying subject received most betting amount. This method can be applied in case when influencing ability of participant to each of the surveying subject is produced in proportion to amount betted by participant.

For instance, in case of survey anticipating a stock price at stock market, a characteristic is anticipated in which the stock price is decided by invested amount of investor who is participant. Accordingly, an influencing ability to stock price becomes relatively bigger by a participant having more in invested amount than a participant having less in invested amount. In this case it can be anticipated that a preference degree of the surveying participant for the surveying subject received most betting is strong. Accordingly, in this embodiment, a dividend is payed which is proportional to amount betted to a participant who selected a surveying subject received most betting amount.

In accordance with the present invention, in one embodiment of a case applying to survey anticipating stock price at stock market, a plurality of particular subject intending to survey is decided by a rising trend, steadiness, and dropping trend of any stock, and a participant analyzes various informations related to stock change and bets to one among a rising trend, steadiness, and dropping trend of any stock whereby anticipating the stock price.

And, in an embodiment executing a survey anticipating the stock price at stock market, at said step S240, a surveying term is decided from any time after closing of stock market up to any time before opening of next stock market, so as to do a bet only during predetermined time period.

Successively at step S270, a statistical analyzation program is used which has developed for this invention seen at web server 22a based on sum of time numbers of selection clicks and betting amount calculated at step S250 and thereby a preference degree and preference strength of plural participants for each surveying subject are analyzed whereby stored to a survey analyzing information storing means 24d.

FIG. 3b is a chart showing sum of selection clicks by participant for each of surveying subjects A1, A2, A3 and A4, in a case exemplified at FIG. 3a. It is interpreted that a preference degree of selection clicks is highest for the surveying subject received most the selection clicks and magnitude of preference degree can be analyzed by its magnitude. And, FIG. 3c is a chart showing sum of betting amount for each of surveying subjects in a case where the surveying subjects are A1, A2, A3 and A4, in an embodiment which applied this invention exemplified at FIG. 3a. Sum of selection click numbers and total betting amount of participant to each of surveying subjects are collected so that preference strength of surveying subject group to each of surveying subject and preference strength by individual of participant can be sought.

In case where average betting amount per participant which selected particular surveying subject is big, it is interpreted that preference degree of participant for corresponding surveying subject is high, and the preference strength can be known by its magnitude.

Accordingly, selection click numbers and total amount of betting amounts are not linked in this invention. There may be a case in which betting amount is relatively less even when particular surveying subject received the selection clicks relatively more and a case in which betting amount is relatively bigger even when it received the selection clicks relatively less. It is interpreted that the preference degree of participant for the surveying subject is low in former case, while the preference strength of participant for the surveying subject is high in latter case.

In above embodiment of the present invention, a case is exemplified in which surveying subject is four, but the numbers of surveying subject of the present invention is not limited by description of embodiment of the present invention.

Accordingly, as described above, in above embodiment of the present invention, a subject preferred by the surveying subject among plurality of the surveying subjects is selected and any investing amount decided by each person is betted, but since dividend is payed to only a participant executed the betting for the subject which received most selection clicks or received most bettings, the participant has a characteristic that he considers popular preference degree of multiple participants participating to survey than a preference degree for the surveying subject of selector own and thereby selecting or betting the subject which is anticipated that most peoples select or most bettings can be received.

And, in selection of subject also, in case when it is convinced that the subject selected by oneself can receive most selection clicks or most bettings, it is anticipated that there would be a characteristic in which the participant bets much amount for the subject selected by oneself in order to obtain much dividend profit. In this invention, it is to analyze the preference strength of participant to each of surveying subjects by utilizing such characteristic.

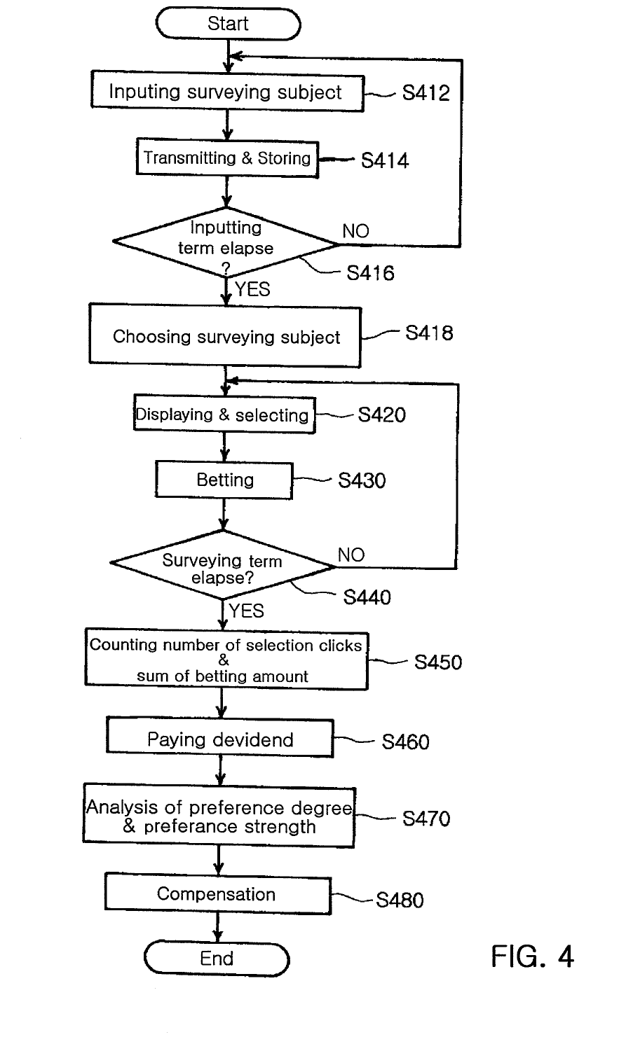

FIG. 4 shows other embodiment applied with the surveying method of the present invention. In this embodiment, the subject of survey is made to input by oneself to any participant who is main body executing the survey S412 and it is transmitted to survey system whereby stored to information storing means 24b.

Subsequently, an operator of survey system judges whether or not previously set predetermined term is elapsed (S416), and in case when it is judged what the time is elapsed, it is characterized to have a step S418 for selecting the surveying subject.

At step S418, the survey system operator is made to select any subject among plurality of surveying subjects which is inputted by any participant whereby stored to information storing means 24b.

Successively, step S420 to step S470 executing the action corresponding to step S220 to step S270 of FIG. 2 are executed.

At step S480, a step is added and executed which analyzes selection click information and betting information of multiple participants whereby executing special compensation to a person who inputted surveying subject which received most selection clicks or received most bettings.

In above described embodiment of the present invention, a step is progressed in which the surveying subject is made to directly input to surveying subject participant who is main body of public opinion formation or to any aspirant, a surveying method according to this invention is executed whereby a subject most preferred by participant is selected, and a betting is done to a participant who did the selection click or betted to the selected subject.

And, in above described embodiment of the present invention, a step is executed which provides particular compensation to a participant who executed the survey and registered by inputting a subject most preferred by participant as a surveying subject.

In accordance with above described embodiment of the present invention, since particular compensation can be received in case where the surveying subject directly inputted and registered by a survey participant who is main body of public opinion formation is selected as a surveying subject and as a surveying result it is selected as a subject most preferred by participant, there would be a tendency inputting by selecting the surveying subject by anticipating what the survey participant most prefers.

Surveying step of the present invention is executed for a selected information which is inputted and registered by any inputting person and thereby preference degree and preference strength of plural participants for plurality of surveying subjects can be surveyed.

The information inputted and registered at said step S412 may be some desiring matter desired to realize by inputting person, or else a problem to be solved in which local residents offers to particular government organization such as local self governing body.

Accordingly, in accordance with above described embodiment of the present invention, since subject of survey is registered voluntarily by the surveying participant who is a forming people of public opinion whereby preference degree of participant to its subject can be instantly analyzed, there is a characteristic that organization such as local self governing body can effectively obtain the information such as desiring matters of residents.

And, an intension of multiplicity of residents can be effectively confirmed by surveying the preference degree and preference strength of multiplicity of residents for the inputted plural participants.

In case of executing above described embodiment of the present invention for a survey to the residents residing at particular region, there is necessity to limit the participants of survey only to residents of its region. It is preferable to utilize for survey by classifying the participants so as to be fit to object of survey by utilizing member information stored to member information storing means.

In surveying method according to the present invention as described above, since not only the paying or not of dividend to participant but also magnitude of dividend to be payed are decided according to result of survey appearing by selection of participant, the participant does prudent responds for surveying matter, therefore reliability of surveying result can be raised.

And, not only preference degree of participant for the surveying subject but also preference strength of participant to each of the surveying subject becomes possible to be statistically analyzed.

And, in case when a subject of survey is made to voluntarily register and the registered surveying subject is selected as highest subject in preference degree by a result of survey, a predetermined compensation is payed to participant registered its subject, and thereby it can easily be extracted what is a subject attracting concerned matter of general mass people.

Above described explanation is no more than explanation for an embodiment of the present invention, and the present invention is possible to variously change and modify within extent of its construction.

What is claimed is:

1. In a method for survey using internet for connecting a computer of participant and a surveying server computer of web site executing the survey through internet whereby surveying a preference degree and preference strength for surveying subject;
a method for internet survey using betting information characterized to survey a preference degree and preference strength for the surveying subject comprising:
a step for inputting and storing a plurality of subjects desired to survey and information related thereto to said server computer;
a step for indicating said stored plural subject and information related thereto to participant computer connected to said server computer and selecting one subject among plural subjects by participant;
a step for inputting a betting amount desired to invest to said selected subject and transmitting to said server computer;
a step for collecting said selecting time numbers for each of plural subjects desired to survey during particular term whereby selecting one subject received most selecting time numbers;
a step for analyzing a preference degree for each of plural subjects based on selecting time numbers to each of plural subjects desired to survey; and
a step for analyzing a preference degree to each of plural subject by sum of inputted betting amount for plural subjects desired to survey.

2. A method for internet survey using betting information characterized to survey a preference degree and preference strength for the surveying subject according to claim 1, which additionally includes a step for analyzing a preference strength by individual for subject selected on the basis of betting amount of each participant to selected subject.

3. A method for internet survey using betting information according to claim 1, wherein said step for analyzing a preference strength includes a step for analyzing a preference strength for each of surveying subject by average betting amount per one person of participant to each of plural subject and dispersing degree of betting amount.

4. A method for internet survey using betting information according to one of claim 1 to claim 3, which additionally includes a step which is made to input a plural subjects desired to survey and informations related thereto to any participant at said participant computer whereby transmitting and storing to said server computer.

5. A method for internet survey using betting information according to claim 4, which additionally includes a step for providing particular compensation to a participant who inputted the subject which received most selection clicks.

6. A method for internet survey using betting information according to claim 4, which additionally includes a step which is made to input said plural particular subject desired to survey and informations related thereto to said server computer during particular term, and which selects a part of surveying subject only among inputted plural surveying subject when particular term is terminated.

7. A method for internet survey using betting information according to claim 4, which additionally includes a step for paying a premium or predetermined amount of cyber money to a participant who inputted plural subject desired to survey and informations related thereto.

8. A method for internet survey using betting information according to claim 1, which additionally includes a step in which participant joins to member of said web site, and which pays predetermined amount of cyber money to a member.

9. A method for internet survey using betting information according to claim 1, wherein the betting is made by cyber money.

10. A method for surveying a preference degree and preference strength for particular subject according to claim 1, wherein said dividend is cyber money.

11. A method for surveying a preference degree and preference strength for particular subject according to claim 1, wherein said plural particular subjects desired to survey are same kind commodies of plural different brands.

12. In method for survey using internet for connecting a computer of participant and a surveying server computer of web site executing the survey through internet whereby surveying a preference degree and preference strength for the surveying subject;
a method for internet survey using betting information characterized to survey a preference degree and preference strength for the surveying subject comprising:
a step for inputting and storing a plurality of subjects desired to survey and information related thereto to said server computer;
a step for indicating said stored plural subject and information related thereto to participant computer connected to said server computer and selecting one subject among plural subjects by participant;
a step for inputting a betting amount desired to invest to said selected subject and transmitting to said server computer;
a step for collecting betting amount for each of plural subject desired to survey during particular term and selecting one subject received most betting amount;
a step for paying a dividend proportional to inputted betting amount to participant who selected a subject received most betting amount;
a step for analyzing a preference degree for each of plural subjects based on selecting time numbers to each of plural subjects desired to survey; and
a step for analyzing a preference degree to each of plural subject by sum of inputted betting amount for plural subjects desired to survey.

13. A method for surveying a preference degree and preference strength for particular subject according to claim 12, wherein said plural particular subjects desired to survey are a rising trend, steadiness, and dropping trend of any stock.

14. A method for surveying a preference degree and preference strength for particular subject according to claim 12, wherein said particular term is from any time after closing of stock market up to any time before opening of next stock market.
